(19) United States
(12) Patent Application Publication
(10) Pub. No.: US 2005/0273406 A1
(43) Pub. Date: Dec. 8, 2005

(54) Method and computer network for co-ordinating a loan over the internet

(75) Inventors: Douglas Lebda, Charlotte, NC (US); Richard Stiegler, Weddington, NC (US)

Correspondence Address: Steven P. Wigmore, Esq.;KING & SPALDING LLP, 45th Floor, 191 Peachtree Street, N.E., Atlanta, GA, 30303, US

(73) Assignee: Lending Tree, Inc., Charlotte, NC (US)

(21) Appl. No.: 10/985,336

(22) Filed: Nov. 10, 2004

Related U.S. Application Data
(63) Continuation of application No. 10/409,647, filed on Apr. 8, 2003, now abandoned.

(51) Int. Cl. G06F 17/60; G06F 17/00

(52) U.S. Cl. 705/35; 707/100

(57) ABSTRACT

The invention relates to a method and a computer for coordinating an electronic credit application between an Internet user and a plurality of lending institutions via the Internet. This method involves displaying documents in a web site, and receiving credit data forming placed on the web site. After receiving this data a special loan processing computer applies a filter to the data. The filter comprises loan selection criteria provided by lending institutions which allows these institutions to filter out loan applications that they do not want. Next, after the data is filtered, it is transmitted to a plurality of lending institutions. Finally, the computer and the method then controls and coordinates communication between these lending institutions and the Internet user to match borrowers and lenders via the Internet.

### BACKGROUND OF THE INVENTION

1. The Field of the Invention

The invention relates to a process for coordinating loans on a loan processing computer over the Internet. The Internet, a vast collection of computers world wide, is a relatively new medium for both personal and commercial entities to transact business. To conduct business over the Internet, companies must find ways to communicate with potential customers. The two most common forms of communication across the Internet are web pages, and e-mail.

2. The Prior Art

Various methods are known for presenting web pages over the Internet. For example, information about the Internet and web browsers can be found in U.S. Pat. No. 5,701,451 to Rogers et al., which is incorporated herein by reference. Rogers et al., details how requests of a web browser are processed. The Rogers invention speeds up the process for receiving requests from web browser users and retrieving the required information. U.S. Pat. No. 5,535,407 to Yanagawa et al., details a customer data processing system which is used to assist credit card purchases made in stores. The Yanagawa invention simplifies the way in which credit card purchases are verified at the time of checkout. U.S. Pat. No. 4,346,442 to Musmanno details a securities brokerage-cash management system. The Musmanno invention maintains customer brokerage accounts, charge cards and checking accounts and calculates available credit for purchases of securities.

Until now, there has been no way to apply for credit from a multitude of lending institutions without physically going to or calling each lender and filling out an application. This process was tedious and time consuming. All applications required substantially the same information: name, address, occupation, debt, amount of loan, etc. This invention combines the vast resources and speed of the Internet with additional knowledge of various lending institution's selection criteria to create a simple mechanism whereby an Internet user can apply for credit from a multitude of lending institutions.

### SUMMARY OF THE INVENTION

To overcome these limitations, it is therefore an object of the present invention to provide a fast, convenient process to apply for credit from a large number of lending institutions. In accordance with our invention, needless repetitive applications are eliminated.

It is a further object of the present invention to provide a universal credit application over the Internet and to allow the Internet user to submit a single credit application to a plurality of lending institutions who then make offers to the customer via the Internet.

To achieve these and other objects of the invention, there is provided a method and apparatus for coordinating an electronic credit application between an Internet user and a plurality of lending institutions via the Internet. The method comprises the steps of displaying a plurality of documents to an Internet user, receiving a plurality of credit data sent from the Internet user; matching an electronic credit application to a filter comprising a plurality of selection criteria; transmitting the credit data to a plurality of lending institutions via one of four methods; and responding to the Internet user via the Internet. The documents sent to the Internet user includes a series of questions pertaining to their desired loan, followed by the appropriate type of loan application. The various types of loan applications include first and second mortgages, car loans, student loans, personal loans, and credit card applications. Other types of credit applications may exist without departing from the spirit of the invention. Upon completion of the application, the invention matches a unique filter to the credit data entered by the Internet user.

The filter is made up of a plurality of selection criteria in which a specific lending institution has given to the inventor. The filter is customizable by the specific lending institution in real time and unique to each lending institution. Once the application has been filtered, it is sent to a list of lending institutions that match with the credit application. These lending institutions then reply as to whether the application has been accepted or rejected.

The information can be sent in many different ways. For example, the information can be sent in an Active File Transfer system (AFTS), via e-mail, through a secured webpage or through a Common Gateway Interface (CGI). In addition, since much of the information relayed between the network of computers is private information, it is encrypted before it is sent from one computer to another.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 shows an overview of the method of the invention;

FIG. 2 shows a schematic depiction of network designed to achieve the method of the invention;

FIG. 3a shows the steps involving the second stage of the lending process;

FIG. 3b shows the steps involving the third stage of the lending process;

FIG. 4 shows the steps of the fourth stage of the lending process;

FIG. 5 shows the steps of the fifth stage of the lending process;

FIG. 6 shows a schematic of the filter process, matching an individual lender to an individual borrower;

FIG. 7 shows the lending process where an individual lender selects from a plurality of borrowers;

FIG. 8 shows the steps of the sixth stage of the lending process;

FIG. 9a shows a schematic of the seventh stage of the lending process;

FIG. 9b shows the various transfer methods in the eighth stage of the lending process; and

FIG. 10 shows the steps of the Active File Transfer System in the eighth stage in the of the lending process;

FIG. 11 shows the steps of the Active File Transfer System in the ninth stage of the lending process; and

FIG. 12 shows the tenth stage of the lending process.

### DETAILED DESCRIPTION OF THE PREFERRED EMBODIMENTS

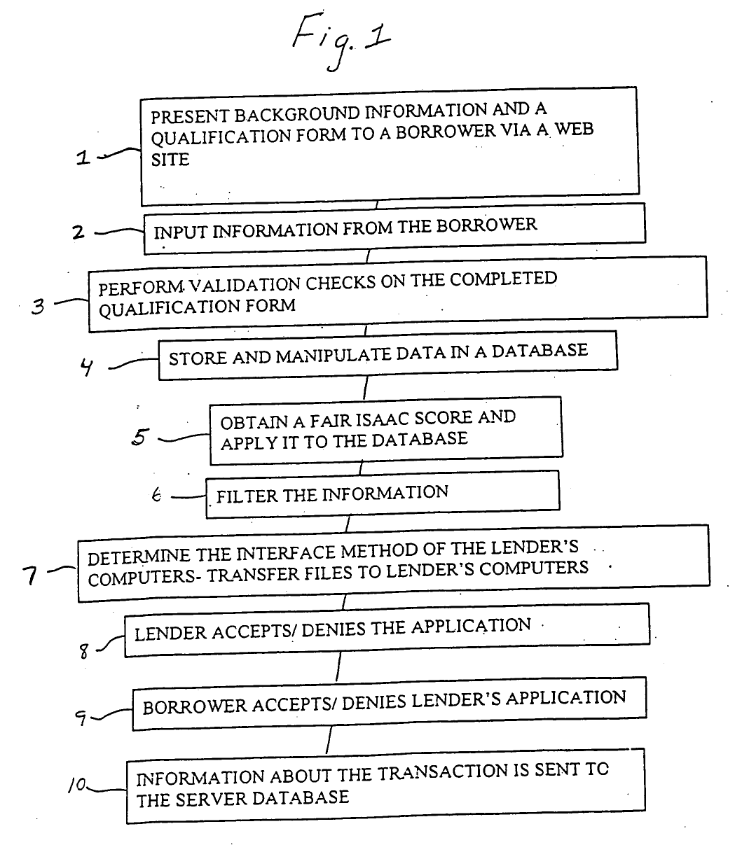

Essentially, the invention is a process and a computer for coordinating loans between lending institutions and borrowers via the Internet. FIG. 1 illustrates the ten general stages in the process required to coordinate an electronic credit application between a prospective borrower and a plurality of lending institutions. For example, in stage 1 the process presents background information and a credit application to a prospective borrower-Internet user on a web site. In stage 2, the prospective borrower inputs information onto the web site. In stage 3, validation checks are performed on this information to make sure that the application is complete and correct. Next, stage 4 involves storing and manipulating the credit application in a database. In stage 5, a Fair Isaac Credit Score is obtained based upon the credit application and that score is matched to the application and stored in the database. Next, in stage 6, the application is filtered where it is compared to a list of criteria presented by a series of lending institutions. If the application passes this list of criteria then in stage 7 the application is sent to each one of those institutions whose criteria match with the application. In stage 8 the lender processes the application and can either accept or deny it. If the lender accepts the application then in stage 9, the borrower can reply stating whether he accepts or denies the lender's application. Finally, in stage 10, information about this transaction is sent to a database to allow lending institutions to have access to their lending history.

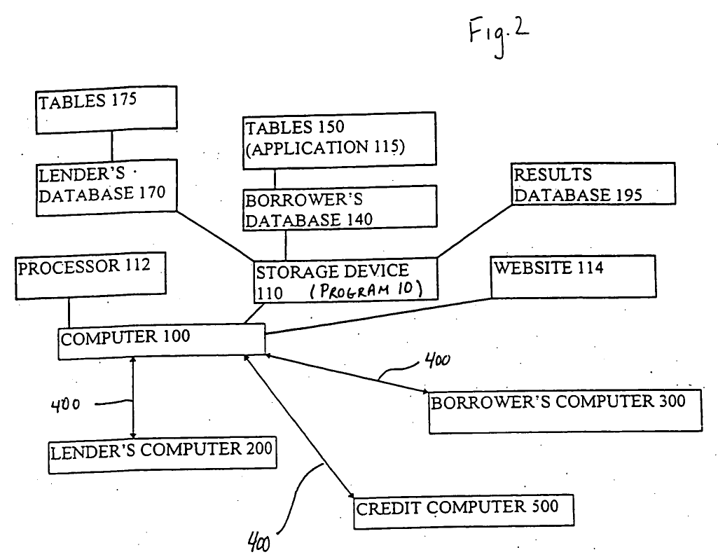

For this process to occur, there must be a series of computers connected to each other via telecommunication lines as shown in FIG. 2. Here, computer program 10, controls the process and is housed on loan processing computer 100. Loan processing computer 100 coordinates a loan application between a series of lending institution computers 200, and a plurality of borrower computers 300. Computer program 10 is stored on loan processing computer 100 in storage device 110 and is run by processor 112. Program 10 is designed to transmit and receive information through the Internet via a web browser such as Netscape or Internet Explorer, installed on the computers.

Loan processing computer 100 must have sufficient memory and processor power to project program 10 over the Internet. Therefore, the recommended minimum requirements for processor 12 on computer 100 is an Intel Pentium 200 Mhz processor. The remaining standard components are 64 megabytes of ram, 2 gigabytes of disk space, an Internet connection, additional Ethernet connection, and Windows NT workstation operating system. Computer 100 is installed with one Ethernet interface directly on the Internet, and the other Ethernet interface connected to a firewall storage device 110, to allow disposition of files on a designated server inside the corporate network. In addition computer 100 could be a Unix style server that interfaces with other Unix and non-Unix based computers on the Internet.

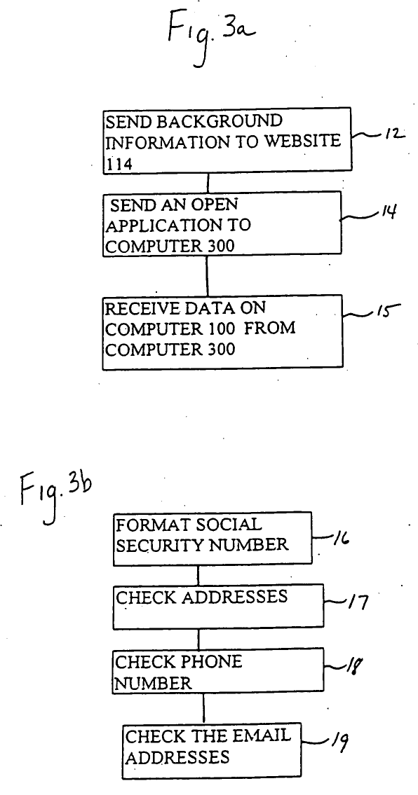

When program 10 runs on computer 100 it instructs computer 100 to interact with other computers through the Internet to co-ordinate a loan application. For example, as shown in FIGS. 1 and 2, in stage 1, computer 100 allows lender computers 200 to access information on web-page 114 housed in loan processing computer 100 at a predetermined URL address via telecommunication lines 400. In stage 2, computer 100 allows prospective borrowers using satellite computers 300 to view a plurality of documents provided by computer 100. Stage 2 consists of a series of steps that are shown in FIG. 3a. For example, in step 12, computer 100 sends the prospective borrower background information documents to web-site 114 concerning the loan application. These background information documents include a document welcoming the Internet user to the web site, a document explaining the application process, and a document explaining the services provided. In step 14, computer 100 sends an open application to a prospective borrower through the Internet to computer 300. In step 15, the prospective borrower inputs information onto the application. When the prospective borrower wants to send this information back to computer 100 he clicks a “SEND” button which initiates the third stage of the program.

FIG. 3b outlines stage 3 wherein computer 100 sends a series of instructions to computer 300 to initiate edit and validation checks. In step 16, computer 100 checks the Social Security number entered. In step 17 computer 100 checks the addresses, in step 18 it checks phone numbers, and in step 19 it checks the email addresses entered. The edit and validation checks in stage 3 insure that the data to be received by the database 140 in computer 100 is in the proper format for further processing. If computer 100 determines that the data is in the proper format, then the borrower can then transmit a completed application 115 to a database on computer 100.

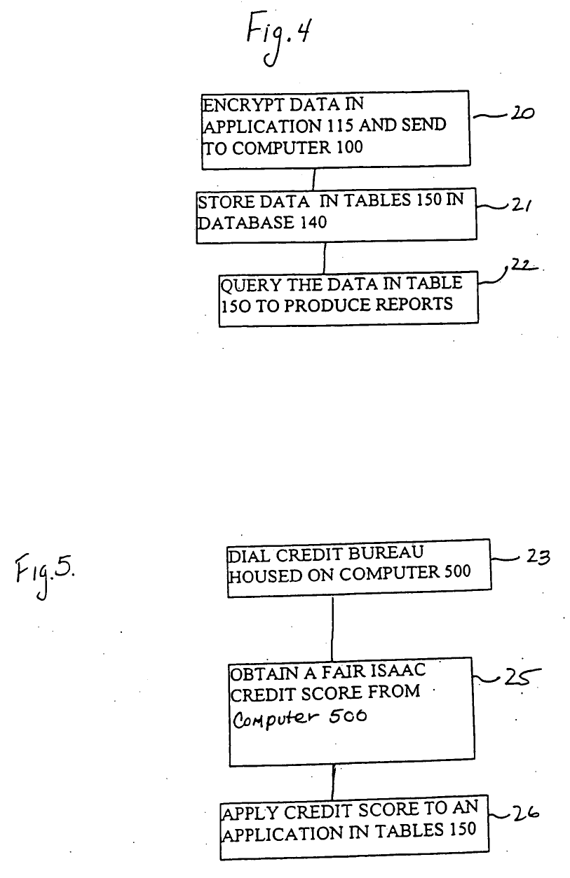

FIG. 4 shows stage 4, wherein in step 20 the data from the completed application 115 is encrypted by SSL technology. Next in step 21, at the borrowers instruction, this information is sent to computer 100, unlocked and stored in storage device 110 for further manipulation. In this stage, the data from completed application 115 is sorted and stored in tables 150 in database 140 based on the type of loan requested (i.e. mortgage, home equity, credit card, etc.). Next, in step 22, program 10 queries the data from tables 150 to produce reports providing loan information based on data given any field in the application form (i.e., state of residence, borrower income, etc.).

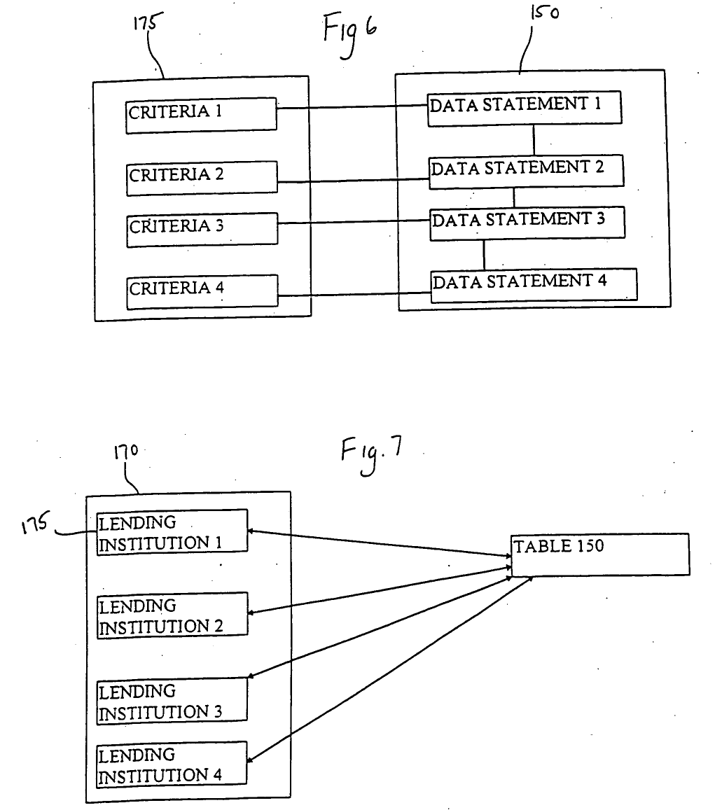

In FIG. 5, computer 100 moves into stage 5, wherein in step 23, computer 100 dials to a credit bureau housed on Credit Computer 500 via telecommunication lines 400. In step 25, computer 100 obtains a Fair Isaac Credit Score from computer 500 based upon the data sent to computer 500. Next, in step 26, computer 100 inputs the Fair Isaac Credit Score to the database tables 150. The lenders can use this Fair Isaac Credit Score as one determinant to the borrower's credit risk.

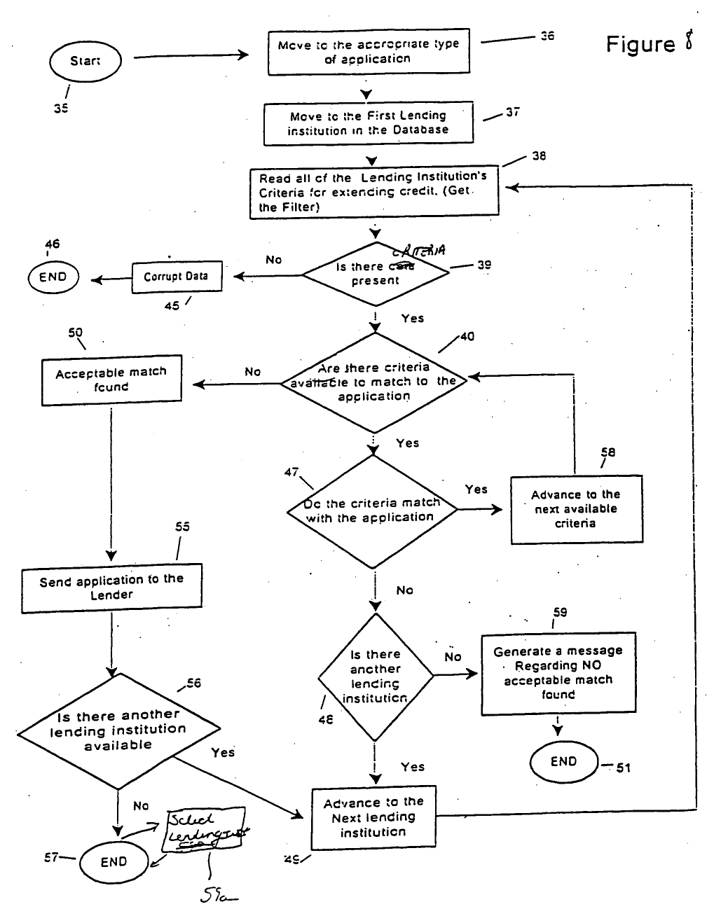

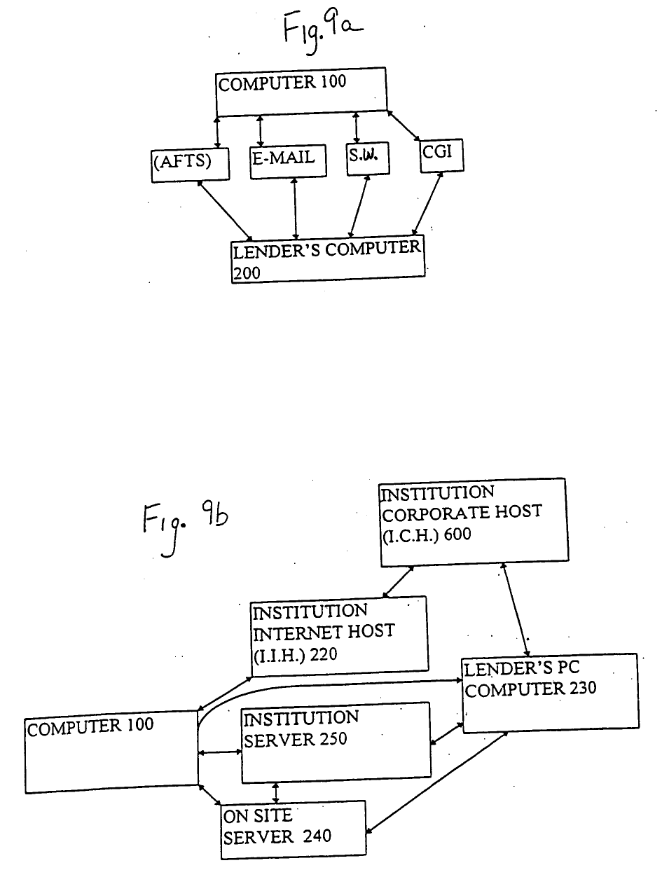

FIGS. 6, 7, and 8 show stage 6 of the process, wherein computer 100 runs a filter to match completed application 115 in table 150 against preset criteria established by each lender. As shown in FIG. 6, lender criteria are stored in tables 175 in lender database 170 on computer 100. Wherein in FIG. 7 lender database 170 includes a listing of tables 175 for several lending institutions. The process for matching borrower's application in tables 150 to lender criteria in tables 175 is shown in FIG. 8. For example, in step 35, program 10 starts the filter process. Next, in step 36, the filter process initiates and moves to the appropriate type application 115 in tables 150. Next, in step 37 the filter moves to a first lending institution in table 175. In step 38, program 10 instructs computer 100 to read all of the lending institution's criteria for extending credit. In step 39, program 10 reads whether there are any criteria present in tables 175. If the requested data is not present, next, in step 45 the filter checks to see if there is any database connection that is broken and whether the database information in the message. If the criteria are present, step 40 instructs computer 100 to see whether any remaining criteria to match to application 115 stored on tables 150.

If there are more criteria to match to application 115, then in step 47, program 10 checks to-see whether that remaining criteria matches with application 115. If the criteria matches with application 115 then in step 58, program 10 advances to the next available criteria in tables 175. As shown in FIG. 6, step 58 creates a loop back to step 40. If the criteria does not match with application 115, then in step 48, program 10 checks to see whether there is another lending institution in database 170. If there are no remaining lending institutions in database 170 then in step 59, computer 100 generates a message that no acceptable match has been found. After this message, in step 51, the filter process ends.

If there is another lending institution found, then the filter process advances to another lending institution in step 49. Step 49 creates a loop back to step 38 wherein the filter process reads all of the criteria for the new lending institution. This loop continues until in step 40, the filter finds there are no criteria available to match to completed application 115.

If there are no more criteria to match to application 115, then in step 50, the filter determines whether there has been an acceptable match between a borrower and a lender. If there is an acceptable match, then in step 55 the filter selects that lender as a suitable lender for application 115.

In step 56 program 10 checks to see if there is another lending institution available, if yes, then program 10 advances to the next lending institution in step 49. If there are no more lending institutions available, then program 10 advances to step 57 wherein the filter process ends. Finally in step 59a computer 100 selects a limited number of matched lending institutions in which to send application 115. For example, if the filter process matches application 115 with 20 lending institutions, computer 100 may send application 115 to only a fraction of those matched lending institutions. This selection process in step 58 is based upon either random selection or a predetermined set of criteria stored in computer 100.

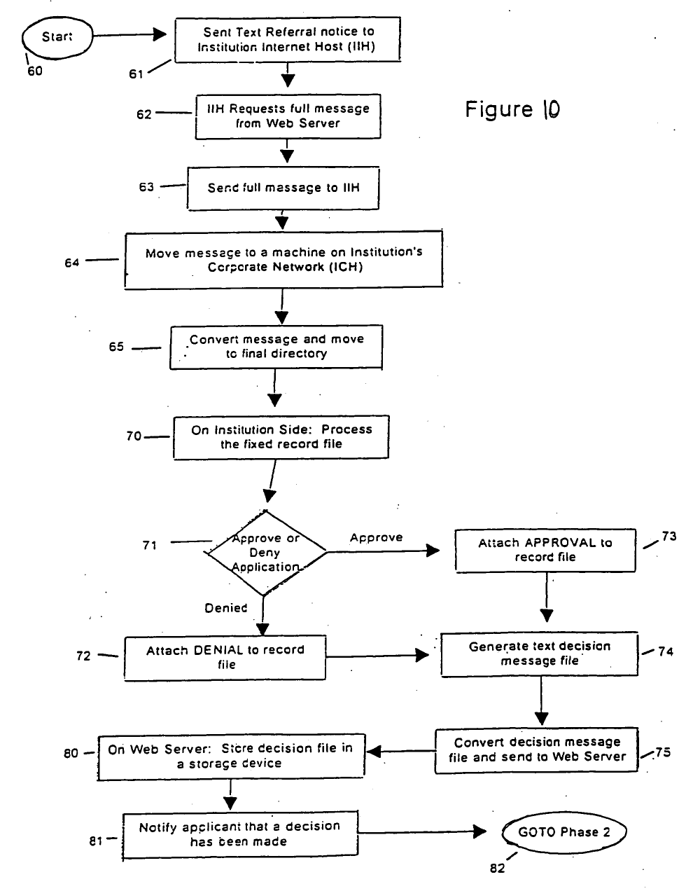

Next, as shown in FIG. 9a in stage 7, program 10 determines the interface method between computer 100 and the selected lending institution computers 200. The interface method can be Common Gateway Interface (CGI), Active File Transfer (AFTS), as a secured file on a secured webpage (S.W.) or via e-mail. Stage 7 allows loan computer 100 to access many different lender sites which thereby allows for greater communication flexibility within the system.

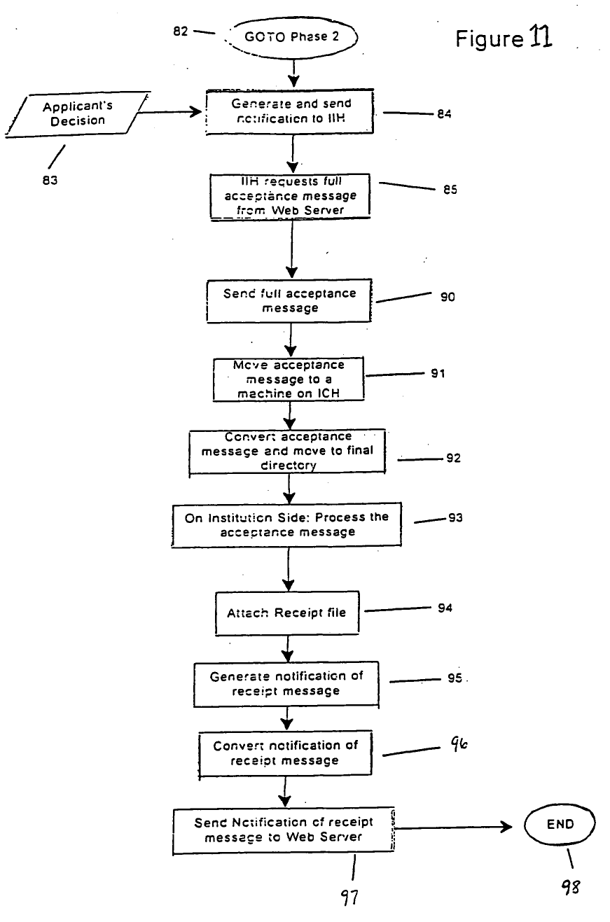

In stage 8, as shown in FIGS. 9a, 9b and 10, computer 100 sends data from table 150 via the interface method selected in stage 7 to the lending institutions selected in the filter process of stage 6. FIG. 10 shows the Active File Transfer System (AFTS) of FIG. 9b in greater detail. For example, in step 60, program 10 instructs computer 100 to start the AFTS. Next, in step 61 a text referral notice is sent to The Institution Internet Host (IIH) computer 220. In step 62, IIH computer 220 requests a full message from computer 100. In step 63 computer 100 sends an encrypted full message to IIH computer 220. Next, in step 64 computer 200 moves the message to the Institution's Corporate Network (ICH) 600. In step 65, ICH 600 converts the message from HTML format to a customized fixed record format defined and controlled by the destination institution. Next, in step 70, outside program 10, this information can be processed and stored in the lender's system. In step 71 the lender approves or denies application 115. If the lending institution approves application 115 it attaches an approval to the record file in step 73. Alternatively if the lending institution denies application 115, then in step 72 it attaches a denial to the record file. In step 74, the lender computers 700 generate a text decision message file. This message file is converted from the existing format into HTML format and sent to computer 100 web-site via encrypted transmission in step 75. The text decision message file contains a loan id number and a request for more information from the borrower. Computer 100 next stores the decision file in database 180 in step 80. Next, in step 81, computer 100 notifies an applicant that a decision has been made.

In addition, the data from credit application 115 can also be sent via e-mail with Pretty Good Privacy (PGP) encryption as shown in FIG. 9b. PGP is an encryption program that can be used to encrypt, a binary file to someone, with very high security, without having to exchange a set of private encryption keys beforehand. In this style transfer system, the text of table 150 comprising credit application 115, is transformed into an e-mail text message. Next, the e-mail message is encrypted in PGP format. Finally, computer 100 sends the e-mail message to computer 230 which is a remote networked computer on a lending institution's site.

The third transfer process, that of the secured dynamic website serves as a place for lenders to log in to a website to change their lending criteria filters and to view loan applications. In this process, information is stored on computer 100 in a website that can be accessed by a lender. To access this site, a lender is given a login access account to log into the website that is encrypted by SSL technology. Once the lender logs into the website he can download information relating to a borrower's request for information.

In the fourth transfer method, the Common Gateway Interface (CGI) format is shown in FIG. 9b. There, computer 100 sends data from table 150 to institution server 250 via a Common Gateway Interface (CGI) program. CGI programs allow for a server to server interface over which encrypted information can be transferred. For example, the data located on table 150 is first encrypted. Next the data can be sent from computer 100 to institution server 250. Server 250 next stores and unlocks the encrypted data. This unlocked data can then be read by all other networked computers 230 in a lender's home network.

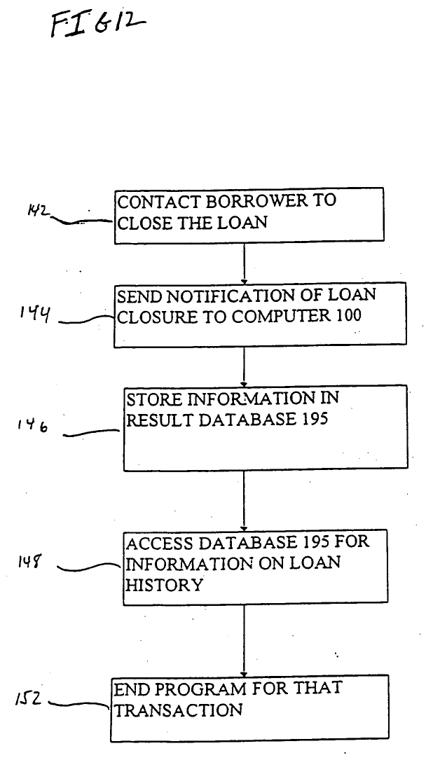

In stage 9, as shown in FIG. 11, computer program 10 moves into the second phase of (AFTS) in step 82. In this stage, the borrower informs the lender of his decision concerning the loan. For example, in step 83 a borrower sends his decision notification from computer 300 to computer 100. Next, in step 84, computer 100 generates and sends a notification to computer 220 (IIH). In step, 85 computer 100 sends a full acceptance message to IIH computer 220 and next moves the acceptance message to ICH computer 600 in step 90. After that, in step 91 ICH computer 600 converts the acceptance message from HTML format and moves it to a final directory 190 on computer 230 (step 91).

At this point the lending institution program takes over so that in step 93, institution computer 230 processes the acceptance message. In step 94, institution computer 230 attaches a receipt file to the acceptance message. In step 95, institution computer 230 generates a notification of receipt message, and in step 96, it converts the notification from its standard database format into HTML format. Finally, in step 97 ICH computer 600 sends a notification of the receipt message to computer 100 and in step 98 the Active File Transfer System ends.

In the tenth and final stage, as shown in FIG. 12, in step 142 the lender contacts the borrower to coordinate the closing of the loan. Here, the lending institution has the borrower's name, social security number, application id number, phone number at both work and home, and the best time to contact the borrower from the acceptance email sent when the offer was accepted. The loan closing can take place in any way that the lender typically closes loans. Once all documents are signed and delivered from the borrower, the loan is closed. Once the lender closes a loan, in step 144 it contacts computer 100 and sends a notification of the loan closure. In step 146 computer 100 stores this information in result database 195 which can be accessed by the lenders in step 148. Finally in step 152, the process according to the invention ends for that individual transaction.

While several embodiments of the present invention have been shown and described, it is to be understood that many changes and modifications may be made thereunto without departing from the spirit and scope of the invention as defined in the appended claims.

1-23. (canceled)

24. A method for identifying a lender for a credit transaction, comprising:
receiving selection criteria from a lender;
receiving credit data from one of a credit applicant and a credit agency; and
automatically applying the selection criteria to determine if the credit data matches the selection criteria, whereby a match results in an identification of the credit applicant as being suitable for completing a commercial transaction with the lender.

25. The method of claim 25, wherein receiving credit data from one of the credit applicant and the credit agency further comprises receiving a credit score about the credit applicant from the credit agency.

26. The method of claim 24, wherein receiving a credit score about the credit applicant from a credit agency further comprises receiving a Fair Isaac Credit Score concerning the credit applicant.

27. The method of claim 24, wherein receiving credit data from one of the credit applicant and the credit agency further comprises receiving a field of information that is part of a qualification form.

28. The method of claim 27, wherein receiving the field of information that is part of the qualification form further comprises receiving at least one of a social security number, address, phone number, e-mail address, state of residence, and income of the credit applicant.

29. The method of claim 24, wherein receiving credit data from one of the credit applicant and the credit agency comprises receiving credit data comprising information relating to one of a first mortgage, a second mortgage, a car loan, a student loan, a personal loan, and a credit card.

30. The method of claim 24, wherein receiving selection criteria from the lender comprises receiving selection criteria comprising criteria defined by the lender and useful for identification of a qualified candidate for one of credit and a loan.

31. The method of claim 24, further comprising:
receiving a selection for a desired type of credit; and
sending a question to the credit applicant pertaining to a desired type of credit.

32. The method of claim 31, further comprising:
receiving an answer to the question pertaining to the desired type of credit;
sending a qualification form to the credit applicant corresponding to the answer to the question pertaining to the type of credit desired by the credit applicant.

33. A method for coordinating a qualification form between an applicant and a lender via a computer network, comprising:
receiving lender selection criteria from the lender;
receiving qualification form data sent from one of the applicant and a third party;
employing the lender selection criteria to automatically determine if the applicant is suitable for completing a commercial transaction.

34. The method of claim 33, wherein receiving qualification form data sent from one of the applicant and the third party further comprises receiving data from a credit agency.

35. The method of claim 33, receiving qualification form data sent from one of the applicant and the third party further comprises receiving a credit score from a credit agency.

36. The method of claim 35, wherein receiving a credit score from the credit agency further comprises receiving a Fair Isaac Credit Score pertaining to the applicant.

37. The method of claim 33, wherein receiving qualification form data sent from one of the applicant and a third party further comprises receiving at least one of a social security number, address, phone number, e-mail address, state of residence, and income of the applicant.

38. The method of claim 33, wherein receiving qualification form data sent from one of the applicant and a third party further comprises receiving credit data comprising information relating to one of a first mortgage, a second mortgage, a car loan, a student loan, a personal loan, and a credit card.

39. A method for coordinating information between a lender and a consumer, comprising:
receiving a selection for a desired type of credit from a consumer;
sending a qualification form to the consumer in response to the credit selection by the consumer; and
applying selection criteria of a lender to automatically determine if credit data from the qualification form as completed by a user matches the selection criteria.

40. The method of claim 39, further comprising receiving qualification form data sent from one of the consumer and a third party.

41. The method of claim 40, wherein receiving qualification form data from one of the consumer and a third party further comprises receiving a credit score about the consumer from a credit agency.

42. The method of claim 41, wherein receiving a credit score about the consumer from the credit agency further comprises receiving a Fair Isaac Credit Score pertaining to the consumer.

43. The method of claim 40, wherein receiving qualification form data sent from one of the consumer and a third party further comprises receiving credit data comprising information relating to one of a first mortgage, a second mortgage, a car loan, a student loan, a personal loan, and a credit card.

44. The method of claim 40, wherein receiving qualification form data sent from one of the consumer and a third party further comprises receiving at least one of a social security number, address, phone number, e-mail address, state of residence, and income of the applicant.

45. The method of claim 39, further comprising displaying a positive credit decision concerning the qualification form and a match with the selection criteria.

46. A system for coordinating business between a computer user and a lender comprising:
a processing unit;
a memory storage device; and
a program module, stored in said memory storage device for providing instructions to the processing unit;
the processing unit responsive to said instructions of said program module, operable for
receiving selection criteria from the lender;
receiving credit data from one of the computer user and a credit agency; and
applying lender selection criteria to determine if the credit data matches the selection criteria.

47. The system of claim 46, wherein the processing unit is further operable for receiving credit data from one of the computer user and the credit agency further comprises receiving a credit score about the computer user from the credit agency.

48. The system of claim 47, wherein the processing unit is further operable for receiving a credit score about the computer user from the credit agency further comprises receiving a Fair Isaac Credit Score pertaining to the computer user.

49. The system of claim 46, wherein the processing unit is further operable for receiving credit data from one of the computer user and the credit agency further comprises receiving at least one of a social security number, address, phone number, e-mail address, state of residence, and income of the computer user.

50. The system of claim 46, wherein the processing unit is further operable for receiving credit data from one of the computer user and the credit agency further comprises receiving credit data comprising information relating to one of a first mortgage, a second mortgage, a car loan, a student loan, a personal loan, and a credit card.

51. The system of claim 46, wherein the processing unit is further operable for receiving selection criteria from the lender further comprises receiving selection criteria from the lender via a computer network operatively coupled to the processing unit.

52. A method for coordinating business between a computer user and a lending institution via a computer network, comprising the steps of:
employing selection criteria to automatically select the lending institution who receives a credit application which results from filtering credit data sent by the computer user; and
posting a positive credit decision from the lending institution on a website in response to a favorable match between the credit data and the selection criteria.

53. The method of claim 52, further comprising receiving credit data sent from one of the computer user and a third party.

54. The method of claim 53, wherein receiving credit data from one of the computer user and the third party further comprises receiving a credit score about the computer user from a credit agency.

55. The method of claim 54, wherein receiving a credit score about the consumer user from the credit agency further comprises receiving a Fair Isaac Credit Score pertaining to the computer user.

56. The method of claim 50, further comprising receiving the selection criteria from the lending institution via a computer network.

57. A method for coordinating a transaction between a computer user and a lending institution via a computer network, comprising the steps of:
sending credit application data over the computer network to the lending institution;
receiving a positive credit decision from the lending institution posted on a website in response to a favorable match between the credit application data and selection criteria managed by the lending institution and stored in a database coupled to the computer network.

58. The method of claim 57, wherein sending the credit application data over the computer network further comprises sending credit application data comprising at least one of a social security number, address, phone number, e-mail address, state of residence, and income of the applicant.

59. The method of claim 57, wherein sending the credit application data over the computer network further comprises sending credit application data comprising information relating to one of a first mortgage, a second mortgage, a car loan, a student loan, a personal loan, and a credit card.
